(19) United States
(12) Patent Application Publication
(10) Pub. No.: US 2004/0261345 A1
(43) Pub. Date: Dec. 30, 2004

(54) Rock facade panel and methods of manufacturing a rock facade panel

(76) Inventor: John McGrath, Toronto (CA)

Correspondence Address: Jenna L. Wilson, Dimock Stratton Clarizio LLP, Suite 3202, Box 102, 20 Queen Street West, Toronto, ON, M5H 3R3, CA

(21) Appl. No.: 10/699,925

(22) Filed: Nov. 4, 2003

(30) Foreign Application Priority Data
Jun. 24, 2003 (CA) 2,433,505

(51) Int. Cl. B44F 9/00

(52) U.S. Cl. 52/506.01; 52/415

(57) ABSTRACT

The invention provides a building panel having a simulated natural rock face, for use as a rock facade in wall construction applications, and methods of manufacturing same. The wall panel is manufactured in a mold containing a masonry-permeable mesh, preferably flexible. In one embodiment the bottom of the mold is provided with the profile of the natural rock facade and the masonry permeable mesh is positioned spaced from the bottom of the mold, and a settable material is poured into the mold, creating the rock facade and simultaneously embedding the mesh in each simulated rock face to integrate the panel. In a further embodiment the mesh is placed over the bottom of a mold, the settable material is poured over the mesh, and the rock facade pattern is pressed or stamped into the top surface of the settable material to create the desired pattern. Optionally the panel has a backing board having holes, the settable material intruding through the holes to anchor the rock façade (and embedded mesh) to the backing board. In a preferred embodiment the panel is provided with top and bottom edges having complementary profiles containing a repeating pattern so that panels can be laid against one another in either a linear or a staggered (overlapping) fashion, and the side edges of the panel are complementary and fit into the repeating portion of the top and bottom edge profile, so that the building panels can be laid either vertically or horizontally.

### FIELD OF THE INVENTION

This invention relates to building construction. In particular, this invention relates to a rock facade panel for use in building construction, and a method of manufacturing same.

### BACKGROUND OF THE INVENTION

Natural rock has been used as a structural element in masonry applications for centuries. A wall or structure constructed from natural rock has a classical appearance which remains highly desirable to this day.

However, modern construction techniques do not readily lend themselves to the use of natural rock as part of a house or other structure. Natural rock walls are typically bulky and irregularly shaped, provide poor insulation, and are extremely labour-intensive to construct so they are very expensive.

One known method of providing the appearance of natural rock on a modern structure without the disadvantages of natural rock is to simulate the look of natural rock by applying a rock façade to a wall. According to this technique rock faces, measuring up to a few inches in thickness, are affixed in a generally random fashion over a substrate or backing such as a steel mesh, which has been anchored to the exterior of a wall. Thus, according to this technique, the wall can be built using a sub-frame composed of modern construction materials, with attendant cost savings and high insulation values, but a simulated rock façade can be applied so that the wall looks like it has been constructed from natural rock.

However, this technique is also very labour intensive. After the mesh has been affixed to the wall a base coat of cementious material is spread over the wire mesh and then scratched and allowed to dry. Then each rock face must be applied to the prepared wall by applying a cementious material to the back of each rock face, pressing the rock face against the prepared wall and holding it until a preliminary set has occurred. This is a task that requires considerable skill and patience, since the rock faces are irregularly shaped and must be selected (and/or shaped) to provide a pattern that appears to be random while covering the entire wall, preferably with relatively uniform grout spacing about the rock faces. The rock faces themselves are costly, and due to the amount of skill and labour involved in properly applying a rock facade to the wall of a building, this is an extremely expensive technique which tends to be available only to the wealthy.

It is known to form construction panels by applying facing materials to a substrate or backboard, for example as described in Canadian Patent No. 2,174,573 issued Jun. 8, 1999 to Hesterman et al., which is incorporated herein by reference. However, while such panels are effective to provide a look of brick, block or some other regular facing material, such panels are ineffective when used with used with irregular facing materials such as natural stone. Since each panel has the sa me shape as every other panel, and particularly where the stone facing is pressed or molded onto the panel, each panel also has the same pattern as every other panel. Once a plurality of panels has been applied to a wall, a pattern starts to appear. It can be difficult or impossible to arrange a plurality of such identical panels in a manner which conceals the pattern of the facing; no matter how random the pattern is on each panel, over successive panels the pattern repeats and this becomes discernible to the eye. This significantly detracts from the effect of using the natural rock facade, since the repeating pattern over successive panels betrays the fact that the wall is a simulation of rock and not natural.

It would accordingly be advantageous to provide a construction panel having a natural rock facade which can be arranged with other identical construction panels to apply a rock facade in a manner which does not provide an obvious repeating pattern, and therefore more closely simulates the random or irregular pattern of natural rock. It would also be beneficial top provide a rock façade panel and a method of making same which simplifies the construction and installation of the rock façade and accordingly substantially reduces the cost and the level of skill required for installation. It would also be advantageous to have a construction panel which can be affixed to a wall without the need for the primary application of wire mesh and cementious scratch coat.

### SUMMARY OF THE INVENTION

The present invention provides a building panel having a simulated natural rock face, for use as a rock facade in wall construction applications, and methods of manufacturing same.

In the preferred embodiment the wall panel is manufactured in a mold containing a masonry-permeable mesh, preferably flexible. In one embodiment of the method of manufacturing the panel, the bottom of the mold is provided with a negative of the profile of the natural rock façade, and the masonry permeable mesh is positioned spaced from the bottom of the mold. A settable material is poured or injected into the mold, creating the rock facade over the entire panel, optionally with a one-half grout façade along the edge profiles, and simultaneously embedding the mesh in each simulated rock face to integrate the panel.

Optionally a backing board having holes, preferably corresponding to the position of each simulated rock face, can be placed over the mesh before pouring or injecting the settable material mixture. With the backing board suspended in the mold above the mesh, the cement intrudes through the holes in the backing board to anchor the rock façade (and embedded mesh) to the backing board. The backing board can be removed prior to installation or additional backing boards may be added to increase insulation value.

Optionally a removable rubber insert which closely follows the shape of the simulated grout lines can be used instead of a backing board, which will act as a seal to, prevent the settable material from entering the grout area, producing a panel with bare mesh in between simulated rock faces. This allows the panel to curve or bend, and improves its fire rating. The simulated grout lines between rock faces can be filled in by piping or otherwise after the panel is installed.

In a further embodiment of the method, the mesh is placed over the flat bottom of a mold (optionally overlaying the backing board if a backing board is used) and the settable material is poured over the mesh. Before the settable material sets, the rock facade pattern is pressed or stamped into the top surface of the settable material to create the desired effect.

The simulated grout lines between simulated rocks may be created when the rock façade is molded, and this is advantageous where a backing board is used because it eliminates the post-installation step of grouting around the simulated rock faces in the panel. However, where the panel is intended to curve or wrap around a corner or other structure, it is advantageous to form the simulated rock faces with bare mesh in between, allowing the panel to curve and bend and improve its fire rating.

In the preferred embodiment of the invention, the rock facade panel is provided with top and bottom edges having complementary profiles, such that the bottom edge of one panel fits contiguously against the top edge of an adjacent panel. In the preferred embodiment, these profiles contain a repeating pattern so that panels can be laid against one another in either a linear or a staggered (overlapping) fashion. Furthermore, in the preferred embodiment the side edges of the panel, which are complementary to one another, also fit into the repeating portion of the top and bottom edge profile. Thus, the building panels can be laid either vertically or horizontally. Optionally, the rock façade panel is provided with side edges also having complementary profiles containing the same repeating pattern as the top and bottom edges, the repeating pattern being configured so that the panels can be laid against one each other in a linear or staggered fashion with any of the top, bottom, or side edges of a first panel in contiguously abutting relation to an adjacent panel. Because of the variety of positions in orientations available for the building panels, it is much easier to conceal the pattern of the building panels.

The preferred embodiment of the invention further provides edge panels, having one straight edge for finishing the bottom, top or side of a wall; two dimensional corner pieces, having two straight edges for finishing the top or bottom corner of a wall; and three dimensional corner pieces, having a straight edge extending into orthogonal planes, for joining orthogonal abutting walls where the rock façade panels are laid over both walls. In each case, the edges of the accessory pieces that are not straight are provided with at least the repeating portion of the top and bottom edge profile.

Optionally, the panels are provided with cutting profiles that are complementary to the top or bottom edge of the panel, and also optionally complementary to the side edge of the panel, such that the panel may be cut without interrupting the simulated rock face to yield a smaller panel that can still be laid in a similar fashion to a full-sized panel.

The invention thus provides a natural looking stone facade which can be applied to a wall with screws, nails, clips or any other suitable fastener; in a fraction of the time presently taken to apply each individual rock face, and can be applied in a manner which results in a random or pseudo random distribution of natural rock faces, eliminating the repetitive pattern which would be formed by laying multiple identical panels in a like configuration and orientation over the area of a wall.

Moreover, the rock façade panel of the invention is easy and inexpensive to manufacture, and simple to install using conventional tools and unskilled labour.

The present invention thus provides a construction panel for applying a simulated rock facade to a structure, comprising: a settable material having an exterior face formed to a desired appearance, and a mesh permeable to the settable material, embedded in the settable material, whereby the mesh integrates a plurality of simulated rock faces, and a plurality of panels can be installed in contiguous abutting relation to simulate a rock wall.

The present invention further provides a method of casting a construction panel, comprising the steps of: a. providing a mold with a bottom comprising a negative profile of a natural rock façade; b. suspending a masonry permeable mesh spaced from the bottom of the mold; and c. pouring a settable material into the mold to at least a level of the mesh; whereby the settable compound sets in the negative rock façade profile to create a plurality of simulated rock faces and simultaneously embeds the mesh in each simulated rock face to integrate the panel.

The present invention further provides a method of casting a construction panel, comprising the steps of: a. laying a mesh over a bottom of a mold; b. pouring a settable material into the mold to above a level of the mesh; and c. before the material sets, pressing or stamping a rock facade pattern into the settable material to create the simulated rock façade pattern.

### BRIEF DESCRIPTION OF THE DRAWINGS

In drawings which illustrate by way of example only a preferred embodiment of the invention,

FIG. 1 is a cross-section of a rock façade panel according to the invention.

FIG. 1A is an elevation of a panel of FIG. 1 before grouting.

FIG. 2 is an exploded elevation showing a plurality of rock facade panels of FIG. 1 in various orientations and positions.

FIG. 3 is an elevation of an edge piece for the panels of FIG. 1.

FIG. 4 is an elevation of a two-dimensional corner for the panels of FIG. 1.

FIG. 5 is a bottom view of a three-dimensional corner for the panels of FIG. 1.

FIG. 6 is a schematic cross-sectional view of a mold for a first preferred embodiment of the method of manufacturing a wall panel according to the invention.

FIG. 7 is a schematic cross-section of a mold for a second preferred embodiment of the method of manufacturing a wall panel according to the invention.

FIG. 8 is an elevation of a second preferred embodiment of a panel according to the invention.

FIG. 9 is an elevation of a third preferred embodiment of a panel.

### DETAILED DESCRIPTION OF THE INVENTION

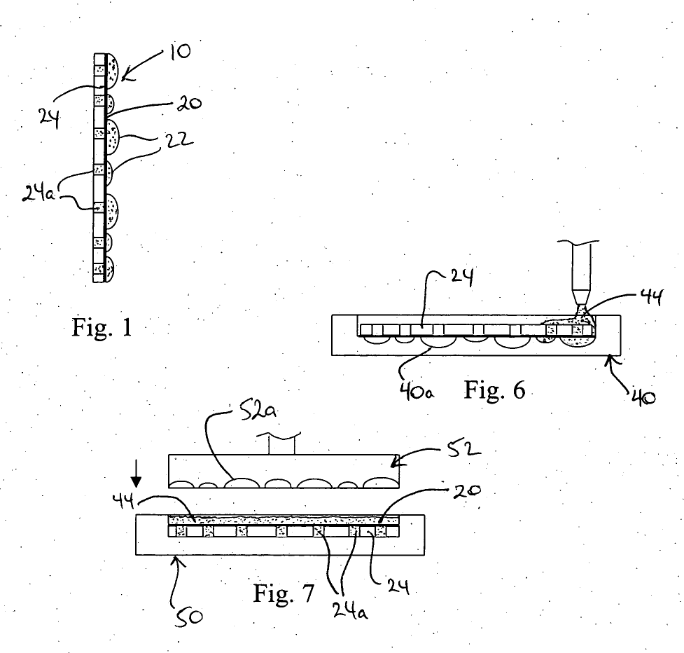

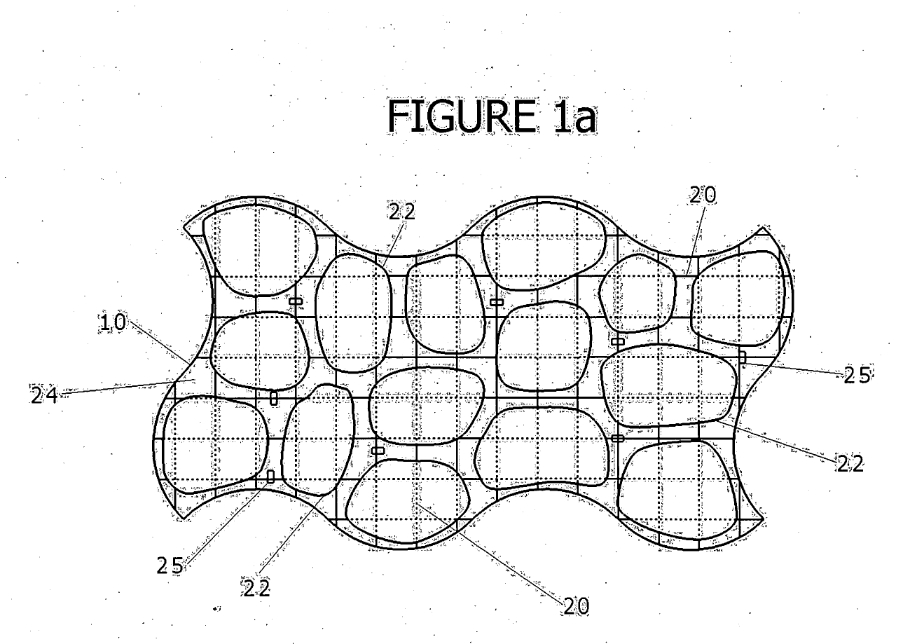

FIGS. 1 and 1A illustrate the preferred composition of the panels 10. The mesh substrate 20 is embedded in each simulated rock face 22, for example by molding the panel 10 as described below. In the embodiment shown the settable material used to create the rock faces 22 also anchors the rock faces 22 and the mesh 20 to an optional backing board 24, which may for example be a foam insulation board, having a periphery cut or otherwise formed to match the shape of the panel 10. The backing board 24 may be composed of any suitable material, but high-density foam insulation board is preferred for its light weight, rigidity and moisture resistance. However, it will be appreciated by those skilled in the art that such a backing board 24 cannot be used near a heat source, such as a fireplace; in these situations either no backing board 24 is used or the backing board 24 must be composed of a fire-resistant material. The mesh 20 may optionally be attached to the backing board 24 by clips 25, as shown in FIG. 1A.

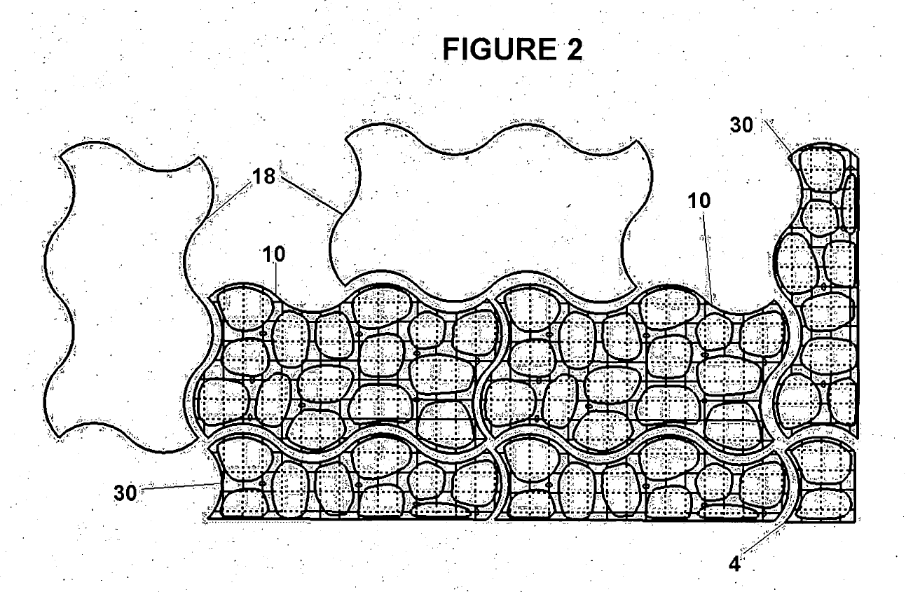

FIG. 2 illustrates a plurality of panels 10 according to the invention (with a slight separation between panels for purposes of illustration). In the preferred embodiment each rock facade panel 10 is provided with top and bottom edges 12, 14 having complementary profiles, such that the bottom edge 14 of one panel fits contiguously against the top edge 12 of an adjacent panel. In the preferred embodiment, the top and bottom edge profiles contain a repeating pattern 18, so that panels 10 can be laid against one another in either a linear or a staggered (overlapping) fashion as shown. The side edges 16 of the panel 10 are complementary to one another and comprise the repeating portion 18 of the top/bottom edge profile. Thus, the building panels can be installed either vertically or horizontally. Installing the panels 10 in random horizontal and vertical orientations makes it easier to conceal the pattern of the building panels 10 and create a random or pseudo-random natural stone pattern in the wall.

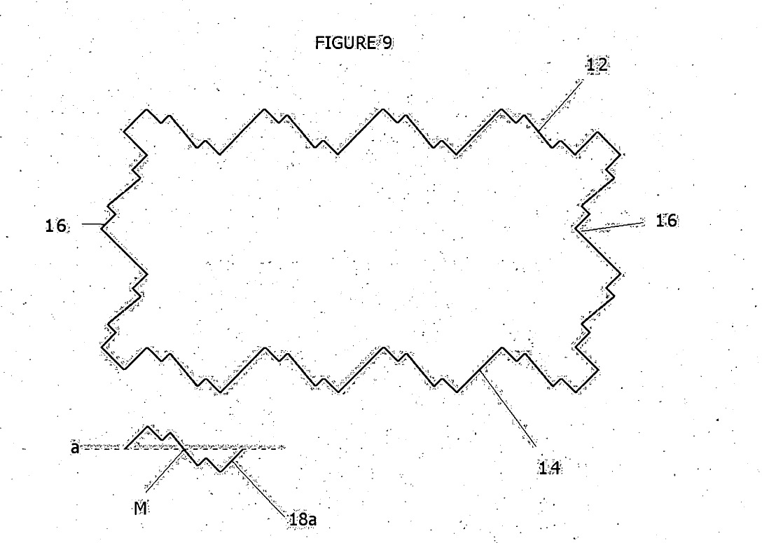

To further enhance the random or pseudo-random stone pattern in the wall, in a preferred embodiment the panel 10 comprises not only top and bottom edges 12, 14 having complementary profiles incorporating the repeating pattern 18, but also side edges 16 incorporating the repeating pattern 18, such that a side edge 16 fits contiguously against a top edge 12, a bottom edge 14, or a side edge 16 of an adjacent panel, as shown in FIG. 8. The repeating pattern 18 must be a periodic edge with a shape that is preserved when it undergoes an inversion operation about its axis a and a phase shift equal to half its period (or alternatively, when the edge is rotated 180° around its midpoint M. In the embodiment of FIG. 8, the repeating pattern 18 is a sinusoidal curve, which is a periodic function that is preserved when it undergoes the described transformation. Each edge of such a panel 10 must comprise an integer multiple of the repeating pattern 18, although the number of repeating patterns 18 along a side edge 16 does not have to equal the number of repeating patterns 18 along a top or bottom edge 12, 14. The size of the rock faces 22 in the panel 10, therefore, will be determined by the size of the repeating pattern 18, and the number of repeats of the pattern 18 along an edge of the panel 10. In a further preferred embodiment, the repeating pattern 18 is a crenated edge such as the jagged edge 18a shown in FIG. 9. The edge 18a is also preserved when it undergoes the transformation described above.

Preferably the settable material comprises a cementious compound such as cement or grout, for example, but any suitable setting compound, polymer or the like may be used, depending primarily upon the weathering conditions to which the wall will be exposed and the desired look of the simulated rock.

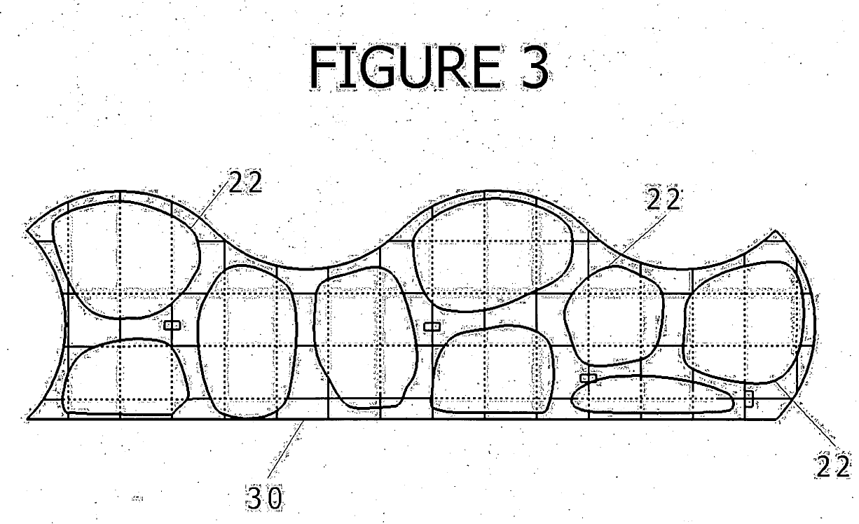

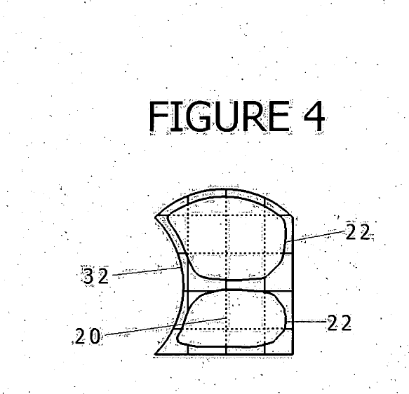

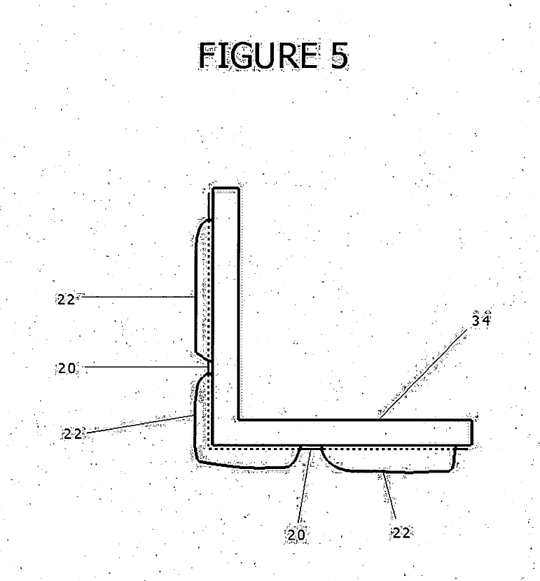

The preferred embodiment of the invention further provides edge panels 30, having one straightedge for finishing the bottom, top or side of a wall; two dimensional corner pieces 32, having two straight edges for finishing the top or bottom corner of a wall; and three dimensional corner pieces 34, having a straight edge extending into orthogonal planes, for joining orthogonal abutting walls where the rock façade panels 10 are laid over both walls; as respectively illustrated in FIGS. 3 to 5. In each case, the edges of the accessory pieces that are not straight are provided with at least one iteration of the repeating portion 18 of the top/bottom edge profile so as to be complementary to the top, bottom or side edges of the panels 10.

The panels 10 may be cut as needed where a partial panel is needed, and individual rock faces can be cut from the panel 10 (with the mesh 20 still embedded) and used to fill areas where a complete panel will not fit. In a preferred embodiment, the panel 10 is provided with at least one cutting profile 60 which traverses the panel 10, as shown in FIG. 8. The cutting profile 60 is complementary to at least one edge 12, 14, or 16 of the panel 10, and contains any repeating pattern 18 that the complementary edge also contains. During manufacture of the panel 10, the rock faces 22 are arranged so as to avoid intersecting the cutting profile 60. Accordingly, the mesh 20 and the backing board 24 can be cut along the cutting profile 60 to yield a lesser dimensioned panel that can be installed in linear, staggered, or random horizontal or vertical orientations in a similar manner to the originally sized panel 10. Preferably, a panel 10 would be provided with a first cutting profile 60 complementary to the top edge 12 or the bottom edge 14, as well as a second cutting profile 62 complementary to a side edge 16, such that when cut along the cutting profiles 60, 62, the panel 10 yields four smaller panels having approximately one-quarter the surface area of the uncut panel 10.

In the preferred embodiment the wall panel 10 is manufactured in a mold. FIG. 6 illustrates a first preferred mold 40 for manufacturing the panel 10 of the invention. The bottom of the mold 42 is provided with a negative profile 40 of the natural rock façade. The masonry permeable mesh 20, which is preferably flexible, is positioned spaced from the bottom of the mold 40. The settable material 44 is poured or injected into the mold 40 to above the level of the mesh 20, filling the negative rock façade profile 40a and thus creating the simulated rock faces 22 over the entire panel 10 (optionally with a one-half grout line along the edge profiles), and simultaneously embedding the mesh 20 in each simulated rock face to integrate the panel 10.

If a backing board 24 is used, the backing board is provided with holes 24a, which may be disposed in a pattern, randomly positioned, or preferably corresponding to the position of each simulated rock face 22 as shown. The backing board 24 is placed over the mesh 20 before pouring the settable material 44, suspended in the mold 40 above the mesh 20. The settable material 44 is poured through the holes 24a to above the bottom surface of the backing board 24, and the cementious mixture intrudes through the holes 24a in the backing board 24 to anchor the rock faces 22 (and embedded mesh 20) to the backing board 24. The backing board 24 may be composed of any suitable material, but high density foam insulation board is preferred for its light weight, rigidity and moisture resistance (except, as noted above, where the installation site is near a heat source). The backing board 24 can optionally be removed prior to installation, if desired.

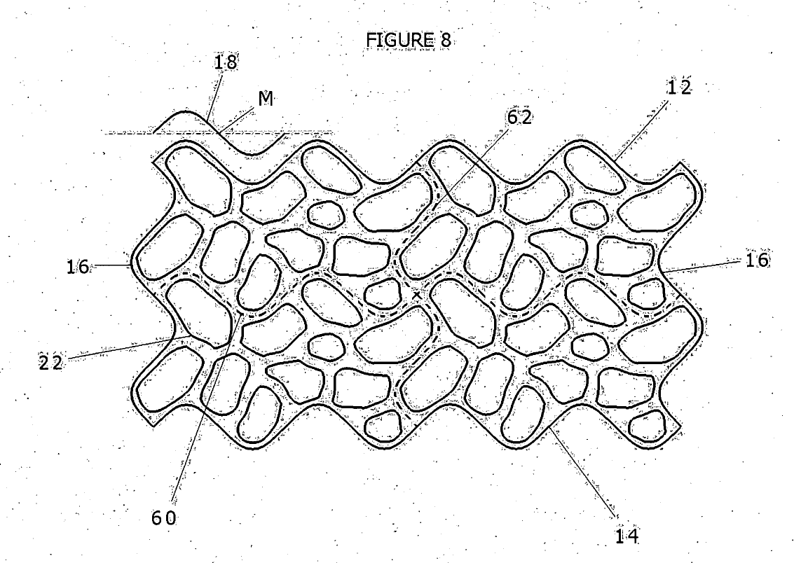

A further mold 50 for manufacturing a rock façade panel 10 according to the invention is illustrated in FIG. 7. In this embodiment, the mesh 20 is placed over the bottom of the mold 50, which may be plain for flat, overlaying the backing board 24 (as shown) if a backing board is used. The settable material 44 is poured over the mesh 20, and before the settable material 44 sets the rock facade pattern is pressed or stamped into the top surface of the settable material by a die 52 having a negative 52a of the rock façade profile, to create the simulated rock façade pattern.

It may be possible to create the simulated grout lines 23 between simulated rock faces 22 when the rock façade panel 10 is molded, by positioning the mesh with a clearance between the mesh and the negative of the rock profile in the mold. This can be advantageous, especially where a backing board 24 is used, because the rock façade panel 10 is rigid through installation and casting the grout lines 23 with the rock faces 22 eliminates the post-installation step of grouting around the simulated rock faces 22 in the panel 10. However, it is advantageous to form the simulated rock faces with bare mesh 20 in between as shown in FIG. 1A, i.e. without casting simulated grout lines, where the panel 10 is intended to curve or wrap around a corner or other structure. This allows the panel 10 to curve, and to some extent bend, without having to break or dislodge rock faces 22. This can be accomplished by disposing the backing board 24 directly on the mesh 20 and in turn disposing the mesh 20 directly on the rock face pattern in the mold 40 or 50 (i.e. leaving no clearance between the mesh 20 and the negative of the rock profile in the mold 40 or 50) as shown in FIGS. 6 and 7, respectively; or by applying a rubber mold insert (not shown) in the shape of grout lines over the mesh 20, which seals around the mesh 20 in the areas of the simulated grout between rock faces, preventing the settable material from entering and covering the mesh 20 in those areas.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A construction panel for applying a simulated rock facade to a structure, comprising:
a settable material having an exterior face formed to a desired appearance, and
a mesh permeable to the settable material, embedded in the settable material,
whereby the mesh integrates a plurality of simulated rock faces, and a plurality of panels can be installed in contiguous abutting relation to simulate a rock wall.

2. The construction panel of claim 1 in which the mesh is flexible.

3. The construction panel of claim 1 in which the rock faces and mesh are anchored to a backing board.

4. The construction panel of claim 3 in which backing board comprises a foam insulation board.

5. The construction panel of claim 3 in which the backing board comprises holes generally aligned with the simulated rock faces.

6. The construction panel of claim 1 in which the settable material forms grout lines between simulated rock faces.

7. The construction panel of claim 1 in which each panel has complementary top and bottom edges, each of said edges comprising a repeating profile whereby a plurality of panels can be installed in contiguous abutting relation with either an entire top edge of one panel abutting an entire bottom edge of an adjacent panel or a portion of a top edge of one panel abutting a portion of a bottom edge of another panel.

8. The construction panel of claim 7 wherein the repeating profile is a periodic curve that is preserved by the transformation comprising an inversion operation and a phase shift equal to half the length of the repeating profile.

9. The construction panel of claim 8 wherein each panel has complementary side edges, each of said side edges comprising the repeating profile whereby a plurality of panels can be installed in contiguous abutting relation with a portion of a top, bottom or side edge of one panel abutting a portion of a top, bottom, or side edge of another panel.

10. The construction panel of claim 7 wherein the panel comprises a cutting profile complementary to the top or bottom edge of the panel and comprising the repeating profile, such that the panel may be cut along the cutting profile to produce a panel with a new top or bottom edge that can be installed in contiguous abutting relation with an adjacent panel, with at least a portion of either the new top or bottom edge of said panel abutting at least a portion of a bottom or top edge of the adjacent panel.

11. The construction panel of claim 9 wherein the panel comprises a cutting profile complementary to the top, bottom, or side edge of the panel and comprising the repeating profile such that the panel may be cut along the cutting profile to produce a panel with a new top, bottom, or side edge that can be installed in contiguous abutting relation with an adjacent panel, with at least a portion of the new top, bottom, or side edge of said panel abutting at least a portion of a top, bottom, or side edge of the adjacent panel.

12. The construction panel of claim 7 in which each panel has side edges each having a profile corresponding to at least a portion of the repeating profile of one of the top or bottom edges whereby a plurality of panels can be installed in contiguous abutting relation with a side edge of one panel abutting a portion of top or bottom edge of another panel

13. The construction panel of claim 12 in which the settable material forms a half grout line around a periphery of the panel.

14. A kit of parts for constructing a rock façade comprising a plurality of construction panels of claim 1 and one or more accessory panels having at least one flat edge for finishing an edge of the rock façade.

15. A method of casting a construction panel, comprising the steps of:
a. providing a mold with a bottom comprising a negative profile of a natural rock façade;
b. suspending a masonry permeable mesh spaced from the bottom of the mold; and
c. pouring a settable material into the mold to at least a level of the mesh;
whereby the settable compound sets in the negative rock façade profile to create a plurality of simulated rock faces and simultaneously embeds the mesh in each simulated rock face to integrate the panel.

16. The method of claim 15 further comprising, before step c., the step of laying over the mesh a backing board having holes, and wherein step c. comprises pouring a settable material into the mold to at least a level of the backing board.

17. A method of casting a construction panel, comprising the steps of:
a. laying a mesh over a bottom of a mold;
b. pouring a settable material into the mold to above a level of the mesh; and
c. before the material sets, pressing or stamping a rock facade pattern into the settable material to create the simulated rock façade pattern.

18. The method of claim 17 further comprising, before step a., the step of laying over the bottom of the mold a backing board having holes, and wherein step a. comprises laying the mesh over the backing board.
